(19) United States
(12) Patent Application Publication
(10) Pub. No.: US 2011/0218304 A1
(43) Pub. Date: Sep. 8, 2011

(54) LOW COST AND HIGH YIELD METHOD OF MAKING LARGE QUANTITY AND HOMOGENOUS METAL NANOPARTICLES AND CONTROLLING THEIR SOLUBILITY

(75) Inventor: Weili SHI, Highland Park, NJ (US)

(73) Assignee: TECONA TECHNOLOGIES, INC., Highland Park, NJ (US)

(21) Appl. No.: 13/039,479

(22) Filed: Mar. 3, 2011

Related U.S. Application Data
(60) Provisional application No. 61/310,006, filed on Mar. 3, 2010.

(51) Int. Cl. C08F 8/42; C08B 37/00; C08F 126/10; B82Y 40/00

(52) U.S. Cl. 525/371; 536/114; 977/896

(57) ABSTRACT

The present invention is directed to a low cost and high yield synthetic method of producing large quantity and homogenous metal nanoparticles, which are capped by both hydrophilic and hydrophobic surfactants and soluble in water, water-miscible solvents, and non-polar solvents. The solubility of metal nanoparticles in different solvents can be controlled by simply changing the ratio of hydrophilic and hydrophobic surfactants.

This application claims benefit of U.S. Ser. No. 61/310,006, filed Mar. 3, 2010, the entire contents and disclosures of which are incorporated by reference into this application.

### FIELD OF THE INVENTION

This invention is directed to a high yield and low cost method of making large quantity and homogenous metal nanoparticles. A method of controlling the solubility of the metal nanoparticles is also presented.

### BACKGROUND OF THE INVENTION

Metal nanoparticles, usually with sizes less than 200 nm, exhibit dramatically different mechanic, electronic, magnetic and optical properties with their counterparts in bulk. They are potentially useful in a variety of applications, such as electronics, catalysis, photonics, metallurgy, and decorations.

To create electronically conductive trace using liquid-based printing techniques for patterning and deposition of conductive inks is of great interest as it represents a much faster and lower-cost technique than traditionally gas phase deposition followed by photolithography. Inks or dispersions containing conductive fillers are printed onto various substrates in one step, therefore reducing the time, cost, and space consumed and the toxic waste created during the traditional manufacturing process. The solution processing-based method has a high rate of throughout and provides enhanced flexibility for choosing both the deposition material and substrate. Printing techniques include screen printing, flexo, gravure printing, inkjet printing etc, and also include spay by a nozzle such as ultrasonic spray nozzle.

A particular interest of metal nanoparticles is to be used as fillers for conductive printable inks or dispersions because of their size-dependent properties such as enhanced dispensability, and greater compatibility with various chemical and physical environments. Due to their small size, nanoparticles exhibit a melting point as low as 1000° C. below the bulk material. For example, silver nanoparticles can sinter at 120° C. which is more than 800° C. below the melting temperature of bulk silver. This lower melting point is a result of comparatively high surface-area-to-volume ratio in nanoparticles, which allows bonds to readily form between neighboring particles. The large reduction in sintering temperature for nanomaterials enables forming highly conductive traces or patterns on flexible plastic substrates, because the flexible substrates of choice melt or soften at relatively low temperature (for example, 150° C.). Upon heating at relatively low temperature, the nanoparticles can sinter and form necking with each other to become a highly conductive trace. Nanoparticle inks are considered necessary where using inkjet printing, because they are small enough to be jetted without plugging the nozzle. Nanoparticles inks also provide finer line, reduced feature and higher resolution. For conductive inks, suitable metal nanoparticle fillers are silver, gold, copper, palladium, nickel, platinum, various silver alloys and other alloys of the kind. Silver is the most widely used materials for conductive inks used in printable electronics. It has the highest conductivity of any metal. It is much lower in cost than gold and possesses much better environmental stability than copper or aluminum.

The vehicle of the conductive inks is usually water, water-miscible organic solvent (such as alcohol, ethylene glycol, etc) or non-polar organic solvent (such as toluene, xylene, etc). To formulate the nanoparticle as conductive ink, the solubility of the nanoparitcle in desired solvent is extremely important. The solubility of the nanoparticle depends on the surfactants, which have affinity to the metal nanoparticle and cap its surface. Depending on the type of the surfactant, the nanoparticle is either hydrophilic (soluble in either water or water-miscible solvent) or hydrophobic (soluble in non-polar solvent).

Numerous references have appeared describing synthesis of metal nanoparticles either in gas phase or in liquid phase. Nanoparticles synthesized in liquid phase synthesis (or colloidal synthesis) have several advantages, such as with narrow size distribution and more chemically processable. However, metal nanoparticles synthesized by existing colloidal method are usually stabilized by one kind of surfactant and are limited to be either hydrophilic or hydrophobic. Further transfer the nanoparticles into other type of solvents will requires the addition of dispersants or polymers, which will hinder the conductivity of the printed trace, therefore degrades the performance of the conductive ink.

U.S. Pat. No. 7,270,694 B2 described synthesis of silver nanoparticles soluble in non-polar organic solvents. U.S. Pat. No. 7,575,621 B2, US Pub. No.2007/0034052 A1, US Pub. No. 2006/0090598 A1 and US Pub. No. 2006/0090597 A1 described polyol-based method for producing metal nanoparitcles soluble in aqueous medium. The quantities of the materials produced by mentioned reference are usually small and measured by metrics of milligrams or grams.

Therefore, a critical need exists, addressed by embodiments of the present invention, for larger quantity, higher yield, lower cost methods of preparing homogenous metal nanoparticles, which are soluble in water, water-miscible solvents, and non-polar solvents.

### SUMMARY OF THE INVENTION

One embodiment of this invention is directed to a low cost and high yield synthetic method of producing large quantity and homogenous metal nanoparticles, wherein the metal nanoparticles are soluble in water, water-miscible solvents, and non-polar solvents. It is further in the scope of the present invention wherein the metal nanoparticles are capped by both hydrophilic and hydrophobic surfactants. In certain embodiment, the solubility of metal nanoparticles in different solvents can be controlled by simply changing the ratio of hydrophilic and hydrophobic surfactants.

Another embodiment of the invention is directed to a process of making metal nanopareticles wherein the metal nanoparticles are capped by both hydrophilic and hydrophobic surfactants, therefore soluble in water, water-miscible solvents and non-polar solvents. Said method comprising steps of (1) obtaining a solution containing a reducible metal precursor dissolved in water or water-miscible solvents; (2) obtaining an aqueous solution containing hydrophilic surfactants; (3) dissolving hydrophobic surfactants in a water-miscible solvent; (4) admixing above three solutions under vigorous agitation to form a homogenous mixture solution; (5) Adding reducing agent solution to above mixture solution to produce nanoparticles; (6) Separating metal nanoparticles from the liquid solution.

### DETAILED DESCRIPTION OF THE FIGURES

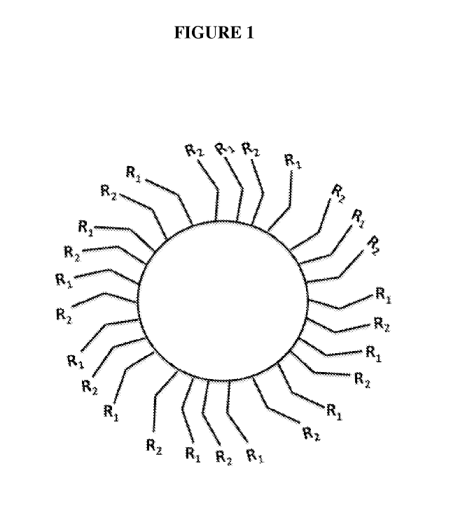

FIG. 1 is a schematic illustration of a metal nanoparticle composition according to the method of the present invention. The nanoparticle is capped with both hydrophilic surfactant (R1) and hydrophobic surfactant (R2).

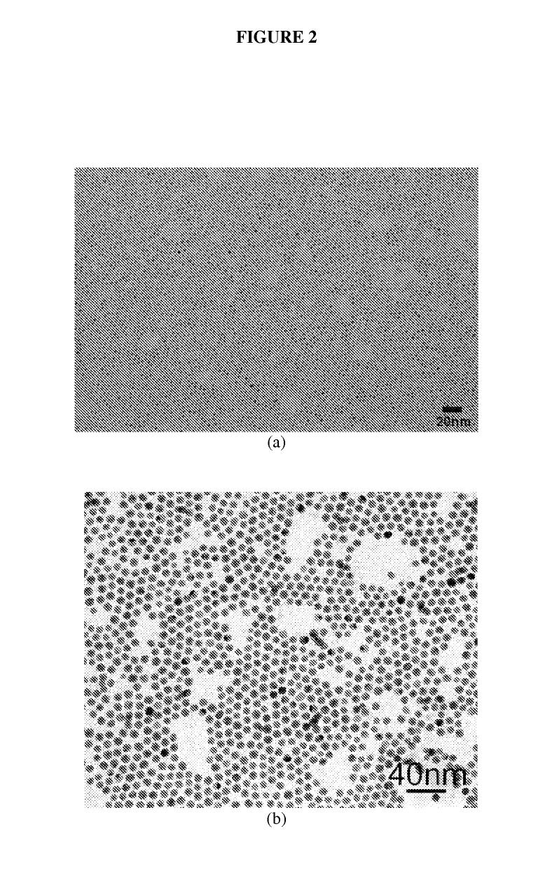

FIG. 2 is Transmission Electron Microscopy Photographs of representative nanoparticles produced by the method of the present invention. The average diameters are a) 3 nm and b) 8 nm.

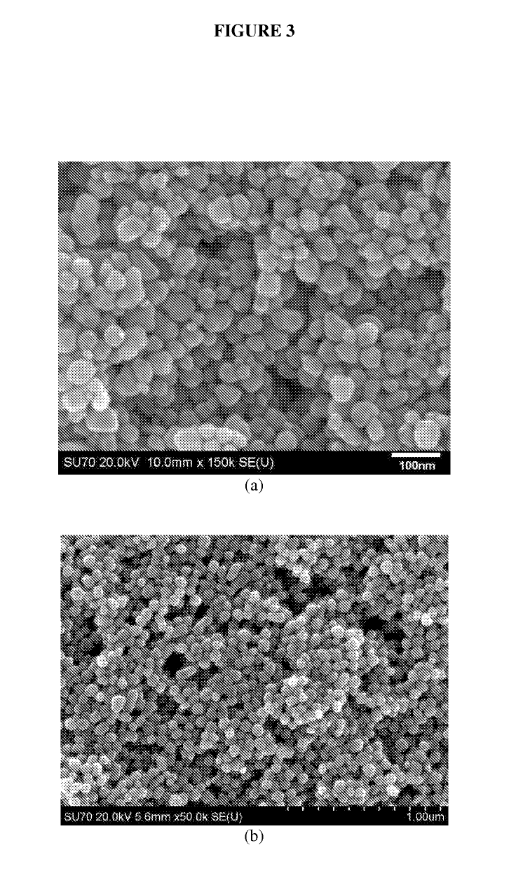

FIG. 3 is Scanning Electron Microscopy Photographs of representative nanoparticles produced by the method of the present invention. The average diameters are a) 25 nm and b) 60 nm.

### DETAILED DESCRIPTION OF THE INVENTION

One embodiment of this invention is directed to a low cost and high yield synthetic method of producing large quantity and homogenous metal nanoparticles, wherein the metal nanoparticles are soluble in water, water-miscible solvents, and non-polar solvents. It is further in the scope of the present invention wherein the metal nanoparticles are capped by both hydrophilic and hydrophobic surfactants. In certain embodiment, the solubility of metal nanoparticles in different solvents can be controlled by simply changing the ratio of hydrophilic and hydrophobic surfactants.

Another embodiment of the invention is directed to a process of making metal nanopareticles wherein the metal nanoparticles are capped by both hydrophilic and hydrophobic surfactants, therefore soluble in water, water-miscible solvents and non-polar solvents. Said method comprising steps of :
1. Obtaining a solution containing a reducible metal precursor dissolved in water or water-miscible solvents;
2. Obtaining an aqueous solution containing hydrophilic surfactants;
3. Dissolving hydrophobic surfactants in a water-miscible solvent;
4. Admixing above three solutions under vigorous agitation to form a homogenous mixture solution;
5. Adding reducing agent solution to above mixture solution to produce nanoparticles;
6. Separating metal nanoparticles from the liquid solution

It is further in the scope of the present invention wherein hydrophilic surfactants are waster soluble resin, selected from (not limited to) gum arabic, ammonium stearate and other stearate salts, Daxad 19, Solsperse, polyethylene glycol, polyvinyl pyrrolidone, polyvinyl alcohol and thereof, cellulose derivatives (e.g. carboxymethyl cellulose, carboxyethyl cellulose, methyl cellulose, etc.) and modified products thereof, polyacrylamide and copolymers thereof, acrylic acid copolymers, vinylmethyl ether-maleic anhydride copolymers, vinyl acetate-maleic anhydride copolymers, various salts of naphthalene sulphonic-formaldehyde copolymers, styrene-maleic anhydride copolymers, calcined dextrin, acid-decomposed dextrin, acid-decomposed etherified dextrin, agarose, and salmon sperm DNA.

It is further in the scope of the present invention wherein hydrophilic surfactants include bi-functional surfactants, such as 11-mercaptoundecanoic acid, 4-mercaptophenol, 1-mercaptohexanol, 4-aminothiophenol, and the like, or mixtures thereof. Weak acid or base may be added to increase the solubility of the bi-functional surfactants in water.

It is further in the scope of the present invention wherein hydrophobic surfactants are selected from (not limited to) thiol and its derivatives, amine and its derivatives, carboxylic acid and its carboxylate derivatives, etc. For example, thoil-consisting surfactants include decanethiol, butanethiol, pentanethiol, hexanethiol, heptanethiol, octanethiol, dodecanethiol, 1,2-ethanedithiol, 1,3-propanedithiol, 1,4-butanedithiol, and the like, or mixtures thereof. Amine-consisting surfactants include propylamine, dodecylamine, ethylamine, butylamine, penylamine, hexylamine, heptylamine, octylamine, nonylamine, decylamine, ethylene-diamine, 1,3-diaminopropane, 1,4-diaminobutane, diaminopentane, dihexylamine, diheptylamine, diaminooctane, propylbutylamine, tributylamine, trihexylamine, butylpentylamine, and the like, or mixtures thereof.

It is further in the scope of the present invention wherein the affinity between the metal nanoparticles and the surfactants can be a chemical bond and/or physical attachment. The chemical bond can take the form of hydrogen bonding, covalent bonding, coordination complex bonding, or ionic bonding, or a mixture of different chemical bondings. The physical attachment can take the form of van der Waal's forces or dipole-dipole interaction, or a mixture of different physical attachments.

It is further in the scope of the present invention wherein a water-miscible solvent is usually alcohol based solvent, selected from (not limited to) acetone, ethanol, methanol, ethyl alcohol, butanol, propanol, pentanol, and the like, or mixtures thereof. Water-miscible solvent also includes ethylene glycol, glycerol, dimethylformamid, dimethylacetamid, acetonitrile, dimethylsulfoxide, N-methylpyrrolidone, and the like, or any mixture thereof.

It is further in the scope of the present invention wherein the reducing agent includes any reducing substance which is capable of reducing metal ions to metallic particles, selected from (not limited to) sodium borohydride, polyhydroxylic alcohols (polyols), reducing saccharides (e.g. glucose, erythrose, threose, dextrose, cellobiose and starch), citric acid, tetrakis(hydroxymethyl)phosphonium chloride, sodium citrate, ascorbic acid, superhydride, hydrazine and its derivatives (e.g. phenyl hydrazine), and the like, or mixtures thereof.

It is further in the scope of the present invention wherein the nanoparticles produced are soluble in water, waster-miscible solvents and non-polar organic solvent. The non-polar solvents are selected from (not limited to) at least one of the group of petroleum ether, hexanes, heptanes, decane, undecane, dodecane, tridecane, tetradecane, octane, nonane, xylene, mesitylene, toluene, benzene, dichloroethane, trichloroethylene, chloroform, dichloromethane, nitromethane, dibromomethane, cyclopentanone, cyclohexanone, and the like, or any mixture thereof.

It is further in the scope of the present invention wherein the relative solubility of the nanoparticles in different solvents can be controlled by adjusting the ratio of hydrophilic surfactants to the hydrophobic surfactants. Increasing the hydrophilic-to-hydrophobic surfactants ratio will produce nanoparticles that have higher tendency to disperse in water or water-miscible solvents. Lower hydrophilic-to-hydrophobic surfactants ratio will result in nanoparitcles that more prefer to non-polar solvents.

It is further in the scope of the present invention wherein the average size of the nanoparticles is controlled by the ratio of the surfactants (hydrophilic and hydrophobic) to metal precursors. Increasing the surfactants-to-precursors ratio decreases the nanoparticle size. Lower surfactants-to-precursors will result in larger nanoparticles. The metal nanoparticles synthesized by the present invention typically have a particle size of for example less than about 200 nm, less than about 100 nm, less than about 50 nm, less than about 20 nm.

In certain embodiments, the metal or mixture of metals (including alloys) is gold, silver, palladium, platinum, copper, chromium, nickel, cobalt, manganese, iron, aluminum, an alkaline earth metal, an alkali metal, a transition metal, a lanthanide, a poor metal, an actinide, or combinations thereof.

It is further in the scope of the present invention wherein the reducible metal precursor is selected from (but not limited to) metal reducible salts and/or metal colloids and/or organic metal compound and/or organic metal complex which can be reduced to form metals.

For example, in case of silver, the reducible precursor can be silver-ammonia complex, silver halide, silver nitrate, silver perchlorate, silver carbonate, silver trifluoroacetate, silver benzoate, silver lactate, silver formate, silver acetate, silver oxalate, ant the like, or mixtures thereof in any suitable ratio. The reducible metal precursor is either soluble in water or water-miscible solvent.

It is further in the scope of the present invention wherein the reaction takes place at room temperature or at elevated temperature, preferably less than 100° C., more preferably less than 80° C.

It is further in the scope of the present invention wherein the surfactants may be removed after the reaction. The resulting metal nanoparticles may be obtained by precipitation, filtration, and centrifugation. The resulting metal nanoparticles have tight size distribution, low degree of agglomeration, high degree of crystallinity, and great solubility in water, water-miscible solvents and non-polar solvents.

FIG. 1 is a schematic illustration of a metal nanoparticle composition according to the method of the present invention. The nanoparticle is capped with both hydrophilic surfactant (R1) and hydrophobic surfactant (R2).

FIG. 2 is Transmission Electron Microscopy Photographs of representative nanoparticles produced by the method of the present invention. The average diameters are a) 3 nm and b) 8 nm.

FIG. 3 is Scanning Electron Microscopy Photographs of representative nanoparticles produced by the method of the present invention. The average diameters are a) 25 nm and b) 60 nm

The invention will be better understood by reference to the Experimental Details which follow, but those skilled in the art will readily appreciate that the specific experiments detailed are only illustrative, and are not meant to limit the invention as described herein, which is defined by the claims which follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### Example 1

### Synthesis of 8 nm Silver Nanoparticles

2 kg silver nitrate was dissolved in 1 L water in a 8 L glass beaker. 2 L ammonium hydroxide was added to the solution to form silver-ammonium complex. 300 g polyvinyl pyrrolidone was dissolved in 300 mL water. 50 g decanethiol was dissolve in 100 mL ethanol. The above three solutions was mixed and stirred at 10,000 rpm to form a homogenous mixture solution. 47.5 g sodium borohydride in 50 mL water was added to the reaction mixture under vigorously agitation. About 1.27 kg silver nanoparticles were collected by filter paper. As-synthesized silver nanopaticles have a tight size distribution with an average size of 8 nm. As-synthesized silver nanopaticles have modest solubility in water and water-miscible solvents (e.g. ethanol) while great solubility in non-polar solvents (e.g. hexanes, xylene).

### Example 2

### Synthesis of 60 nm Silver Nanoparticles

4 kg silver chloride was dissolved in 3 L water in a 8 L glass beaker. 800 g gum arabic was dissolved in 400 mL water. 20 g dodecylamine was dissolve in 100 mL ethylene glycol at 50° C. The above three solutions was mixed and stirred at 10,000 rpm to form a homogenous mixture solution. The reaction mixture was heated to 50° C. 238 g hydrazine hydrate was added to the reaction mixture under vigorously agitation. About 3 kg silver nanoparticles were collected by centrifugation. As-synthesized silver nanopaticles have a tight size distribution with an average size of 60 nm. As-synthesized silver nanopaticles are readily soluble in water, water-miscible solvents (e.g. ethanol) and have moderate solubility in non-polar solvents (e.g. toluene, dodecane).

What is claimed is:

1. A process comprising steps of (a) obtaining a solution containing a reducible metal precursor dissolved in water or water-miscible solvents; (b) obtaining an aqueous solution containing hydrophilic surfactants; (c) dissolving hydrophobic surfactants in a water-miscible solvent. (d) admixing above three solutions under vigorous agitation to form a homogenous mixture solution; (e) adding reducing agent solution to above mixture solution to produce nanoparticles; (f) separating metal nanoparticles from the liquid solution.

2. The process of claim 1, wherein the metal nanoparticles are capped by both hydrophilic and hydrophobic surfactants.

3. The process of claim 1, wherein the metal nanoparticles are soluble in water, water-miscible solvents, and non-polar solvents.

4. The process of claim 1, wherein the solubility of metal nanoparticles in different solvents can be controlled by changing the ratio of hydrophilic and hydrophobic surfactants.

5. The process of claim 1, wherein the hydrophilic surfactant is water soluble resin.

6. The process of claim 1, wherein the hydrophilic surfactant is bi-functional surfactant.

7. The process of claim 1, wherein the hydrophobic surfactant is thiol and its derivatives.

8. The process of claim 1, wherein the hydrophobic surfactant is amine and its derivatives.

9. The process of claim 1, wherein the hydrophobic surfactant is carboxylic acid and its carboxylate derivatives.

10. The process of claim 1, wherein the average size of the nanoparticles is controlled by the ratio of the surfactants (hydrophilic and hydrophobic) to metal precursors.

11. The process of claim 1, wherein the reaction of the metal precursor with the reducting agent is carried out at a temperature below 100° C.

12. The process of claim 1, wherein the average size of the nanoparticles is less than about 200 nm.

13. The process of claim 1, wherein the average size of the nanoparticles is less than about 100 nm.

14. The process of claim 1, wherein the metal is selected from gold, silver, palladium, platinum, copper, chromium, nickel, cobalt, manganese, iron, aluminum, an alkaline earth metal, an alkali metal, a transition metal, a lanthanide, a poor metal, an actinide, or combinations thereof.

15. The process of claim 1, wherein the metal nanoparticle has a tight size distribution.

16. The process of claim 1, wherein the metal nanoparticle has a low degree of agglomeration.

17. The process of claim 1, wherein the metal nanoparticle has a high degree of crystallinity.

18. The process of claim 1, wherein the metal nanoparticle has a great solubility in water, water-miscible solvents and non-polar solvents
